(19) United States
(12) Patent Application Publication
(10) Pub. No.: US 2024/0027018 A1
(43) Pub. Date: Jan. 25, 2024

(54) BRACKET ANCHOR

(71) Applicant: PohlCon GmbH, Berlin (DE)

(72) Inventors: Dersu YILMAZ, Berlin (DE); Nico STIBITZ, Teltow (DE); Henning Roessel, Berlin (DE); Stephan Muelow, Ludwigsfelde (DE)

(21) Appl. No.: 18/356,705

(22) Filed: Jul. 21, 2023

(30) Foreign Application Priority Data
Jul. 22, 2022 (DE) 10 2022 002 680.5

(51) Int. Cl. F16M 13/02

(52) U.S. Cl. CPC F16M 13/02

(57) ABSTRACT

The invention relates to a bracket anchor for fastening a facing to a structure, the bracket anchor comprising a bracket head for fastening the bracket anchor to the structure, a bridge element, a support element for supporting the facing and a pressure element for transmitting pressure from the bracket anchor to the structure, wherein the support element and the pressure element are fixed to the bridge element, wherein the bridge element comprises a tension strut and a compression strut, and wherein the tension strut and the compression strut are connected to each other only at their ends facing the support element. It is characterized in that the bridge element is designed at least in two parts, the tension strut and the compression strut being connected to one another in a force-fitting, form-fitting or material-fitting manner.

### FIELD OF THE INVENTION

The invention relates to a bracket anchor for securing a facing to a structure, the bracket anchor comprising a bracket head for securing the bracket anchor to the structure, a bridge member, a support member for supporting the facing, and a pressure member for transmitting pressure from the bracket anchor to the structure, wherein the support member and the pressure member are fixed to the bridge member, wherein the bridge member comprises a tension strut and a pressure strut, and wherein the tension strut and the pressure strut are connected to each other only at their ends facing the support member.

### PRIOR ART AND BACKGROUND OF THE INVENTION

Bracket anchors of the structure mentioned at the beginning are known, for example, from the literature reference EP 3 239 431 A1. In this insofar known bracket anchor, the bridge element is made of one piece, typically punched or cut out of a metal sheet. This is why it is also called “bridge plate” there. This requires that the tension strut and the pressure strut have the same thickness, namely the thickness of the sheet from which the bridge element is formed. This leads to constraints in the static design, where it must be ensured, for example, that the pressure strut does not buckle under load. This requires either a very thick bridge element overall or, as described in the literature, the need to attach a bend to the pressure strut, either by folding or by attaching it. This is costly and also imposes constraints on the static dimensioning of the elements of the bracket anchor, which ultimately also result in an overall weight that can be improved.

In the case of the known bracket anchor, the bridge element is cut out of a sheet. This inevitably results in offcuts, since the complex-shaped bridge element cannot be projected onto the sheet metal half-finished product so often that no offcuts occur. This is a nuisance against the background of increasingly scarce and expensive raw materials and energy resources.

Bracket anchors are further known from DE 10 2020 111 864 A1 and EP 3 489 430 A1. In both cases, the pressure elements are rod-shaped, which entails static disadvantages.

### TECHNICAL PROBLEM OF THE INVENTION

The invention is therefore based on the technical problem of specifying a bracket anchor that is simple to manufacture, particularly flexible in the dimensioning and optimization of the elements, and can be manufactured in a way that saves resources.

Main features of the invention and preferred embodiments

To solve this technical problem, the invention teaches that the bridge element is formed in at least two parts, wherein the tension strut and the pressure strut are plate-shaped and are connected to each other in a force-fit, form-fit or material-fit manner.

A plate-shaped design refers to a design with a substantially rectangular cross-section, wherein the main surfaces of the plates are substantially vertical.

The invention achieves several advantages in combination.

First, it becomes possible to dimension the tension strut and the pressure strut completely free of constraints independently of each other. In particular, this makes it possible to dimension the thickness of the pressure strut to prevent buckling in such a way that the cross-section and thus the material consumption is minimized and additional elements to prevent buckling at the pressure strut can be dispensed with. In particular, stiffening elements at an angle to the pressure strut can be dispensed with.

Furthermore, it is possible to dispense with variable widths for the pressure strut and the tension strut in the direction of their longitudinal extension. As a result, the semi-finished product used is in particular strip material from which the pressure strut and the tension strut are cut to the required length. As a result, there is virtually no waste and the work is very advantageous in terms of material usage and the associated costs.

At the same time as the static optimization, it is also possible to optimize the thermal conductivity by selecting materials and dimensioning the components of the bracket anchor, in the sense that the thermal conduction between the facing and the structure is minimized.

The aforementioned advantages significantly overcompensate for the additional manufacturing step, which consists of connecting the pressure strut to the tension strut.

Various advantageous further embodiments are possible within the scope of the invention.

For example, the tension strut may have a thickness d1 and the pressure strut may have a thickness d2, where d1 and d2 are substantially equal. If at the same time the widths b1 and b2 are the same and constant in the direction of the longitudinal extension of the tension strut and/or the pressure strut, then a single strip material is required as a semi-finished product for the bridge element. This is particularly advantageous for the production process and material stocking.

Of course, it is also possible, if necessary, to make the widths b1 and b2 variable or variable in the longitudinal extension of the pressure strut and/or the tension strut.

However, it can also be provided that d1 and d2 are different. For example, the ratio of the thicknesses d1/d2 can be in the range from 1:1.01 to 1:5, in particular 1:1.01 to 1:2. Then the pressure strut and the tension strut can be statically optimized independently of each other, resulting in the lowest possible overall weight. On the one hand, this is advantageous when using the finished bracket anchor at the construction site, as lower weights can be handled on site. On the other hand, valuable material resources are optimally utilized.

Under certain circumstances, optimum static dimensioning may make it desirable for the widths b1 and b2 to be different. The ratio of the widths b1/b2 can then be in the range between 1.0 and 0.1, in particular in the range between 0.8 and 0.3.

The thicknesses d1 and d2 typically range from 1 to 20 mm, in particular from 1 to 10 mm. The widths b1 and b2 are typically in the range from 80 to 10 mm, in particular from 50 to 20 mm.

The tension strut and pressure strut are preferably at an angle of 20 to 70°, in particular 40 to 50°, the angle being measured between the center axes of the pressure strut and the tension strut.

Advantageously, at least the tension strut (8) and the pressure strut (9), and preferably also the bracket head (4), the pressure element (7) and/or the support element (6) are made of a metallic material, in particular an aluminum alloy or a steel alloy.

In principle, any customary way of firmly joining the pressure strut and the tension strut (and also the other components of the bracket anchor at the tension and/or pressure strut) is possible. For example, the tension strut and the pressure strut may be bolted, riveted, or welded together.

The support element, pressure element and bracket head may be formed and dimensioned in any manner customary in the art.

Bracket anchors according to the invention can be used for any type of facing. Façade panels of any material, insulating panels, precast concrete elements, for example sandwich elements, stones, in particular masonry blocks, or stone slabs are all suitable.

Structures can be residential buildings or commercially usable buildings, but also small buildings such as garages and the like. Typically, a bracket anchor according to the invention is attached to the supporting structure made of reinforced concrete.

### BRIEF DESCRIPTION OF THE DRAWINGS

In the following, the invention is explained in more detail with the aid of figures illustrating only examples of embodiments. They show

FIG. 1: a side view of a bracket anchor according to the invention and

FIG. 2: a perspective view of a bracket anchor according to the invention.

### DETAILED DESCRIPTION OF THE INVENTION

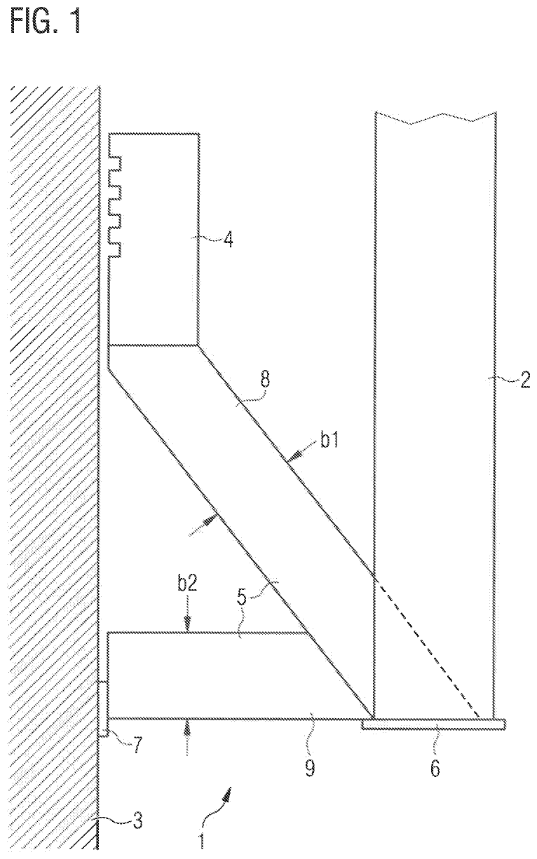

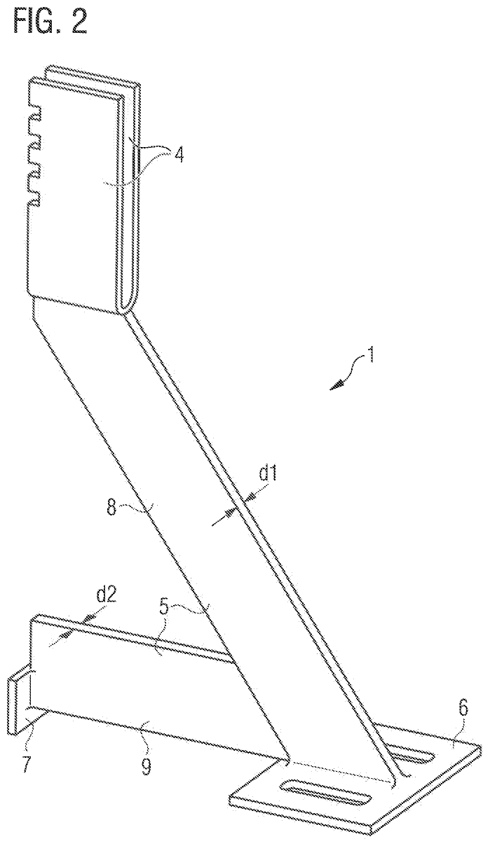

In FIG. 1, one can see a bracket anchor 1 for fastening a facing 2 to a structure 3. A comparative view of FIGS. 1 and 2 reveals that the bracket anchor 1 comprises a bracket head 4 for fastening the bracket anchor 1 to the structure 3, a bridge element 5, a support element 6 for supporting the facing 2 and a pressure element 7 for transmitting pressure from the bracket anchor 1 to the structure 3. The support element 6 and the pressure element 7 are fixed to the bridge element 5, in the embodiment example welded. The bridge element 5 comprises a tension strut 8 and a pressure strut 9. The tension strut 8 and the pressure strut 9 are connected to each other only at their ends facing the support element 6, in the embodiment example welded to each other. The bridge element 5 is made of two parts.

The tension strut 8 has a thickness d1 and the pressure strut 9 has a thickness d2, where d1 and d2 are substantially equal. Alternatively, d1 and d2 can be different.

The tension strut 8 has a width b1 and the pressure strut 9 has a width b2, which is constant in the direction of the longitudinal extension of the tension strut (8) and/or the pressure strut (9) in the embodiment example. Furthermore, the widths b1 and b2 are the same. As a result, the pressure strut and the tension strut can be cut from one and the same strip material.

The tension strut 8, the pressure strut 9, the bracket head 4, the pressure element 7 and the support element 6 are formed from a steel alloy, for example stainless steel. Stainless steel ensures comparatively low thermal conductivity of the bracket anchor 1. The protruding elements are all welded together.

1. A bracket anchor for fastening a facing to a structure, the bracket anchor comprising a bracket head for fastening the bracket anchor to the structure, a bridge element, a support element for supporting the facing and a pressure element for transmitting pressure from the bracket anchor to the structure, wherein the support element and the pressure element are fixed to the bridge element, wherein the bridge element comprises a tension strut and a pressure strut, and wherein the tension strut and the pressure strut are connected to each other only at their ends facing the support element, wherein
the bridge element is formed at least in two parts, the tension strut and the pressure strut being of plate-like design and being connected to one another in a force-fitting, form-fitting or substance-fitting manner.

2. The bracket anchor according to claim 1, wherein the tension strut has a thickness d1 and the pressure strut has a thickness d2, d1 and d2 being substantially equal.

3. The bracket anchor according to claim 1, wherein the tension strut (8) has a thickness d1 and the pressure strut has a thickness d2, where d1 and d2 are the same or different.

4. The bracket anchor according to claim 3, wherein the ratio of the thicknesses d1/d2 is in the range from 1:1 to 1:5, in particular 1:1 to 1:2.

5. The bracket anchor according to claim 1, wherein the tension strut has a width b1 and/or the pressure strut has a width b2 which is variable or constant in the direction of the longitudinal extension of the tension strut and/or the pressure strut (9).

6. The bracket anchor according to claim 1, wherein the widths b1 and b2 are equal.

7. The bracket anchor according to claim 1, wherein the widths b1 and b2 are different.

8. The bracket anchor according to claim 7, wherein the ratio of the widths b1/b2 is in the range between 1.0 and 0.1, in particular in the range between 0.8 and 0.3.

9. The bracket anchor according to claim 1, characterized in that at least the tension strut and the pressure strut, preferably also the bracket head, the pressure element and/or the support element are formed from a metallic material, in particular from an aluminum alloy or steel alloy.

10. The bracket anchor according to claim 1, characterized in that at least the tension strut and the pressure strut are screwed, riveted or welded together.
